(19) United States
(12) Patent Application Publication
(10) Pub. No.: US 2008/0206077 A1
(43) Pub. Date: Aug. 28, 2008

(54) Wave Pump Device

(76) Inventor: Dagfinn Royset, Trondheim (NO)

Correspondence Address: PATTERSON & SHERIDAN, L.L.P., 3040 POST OAK BOULEVARD, SUITE 1500, HOUSTON, TX, 77056, US

(21) Appl. No.: 11/915,220

(22) PCT Filed: May 18, 2006
(86) PCT No.: PCT/NO06/00185

§ 371 Date: Dec. 7, 2007

(30) Foreign Application Priority Data
May 25, 2005 (NO) 20052504

(51) Int. Cl. F03B 13/20; F03B 13/16; E02B 9/08

(52) U.S. Cl. 417/333; 417/61; 417/331

(57) ABSTRACT

A wave pump device (1) comprising a pump part (2) connected to a pontoon (4, 50), wherein the pump part (2) is further connected to at least one submerged water anchor (12).

This invention regards a wave pump. More particularly, it regards a wave pump comprising a pontoon connected to a submerged pump, where at least one water anchor prevents the submerged pump from following the vertical motion of the pontoon.

Several designs of prior art wave pumps are known. One embodiment that has gained a fair amount of use is a pump clamped between a pontoon on the surface of the sea and the seabed or optionally a weight located on the seabed. The actual pump may be located in the pontoon or on the seabed and be connected to the seabed or pontoon, respectively, by a line.

This type of wave pump is typically used to drive a turbine connected to a generator for generation of electric power.

Large waves suitable for energy extraction on a commercial basis often occur in offshore locations of relatively great depths. Thus floating wave pumps of said type must be connected to the seabed by a relatively long line.

Due to practical reasons it is inexpedient to locate the pump itself on the seabed, especially in the case of great ocean depths, relatively large pumps and when pumps are to be connected to a common turbine plant. Such a solution would require a relatively long and heavy pressure line to the surface, and would also complicate maintenance and inspection.

The object of the invention is to remedy or reduce at least one of the drawbacks of prior art.

The object is achieved in accordance with the invention, by the features specified in the description below and in the following claims.

A wave pump in accordance with the invention comprises a pump part connected to a pontoon, the pump part further being connected to at least one submerged water anchor.

Advantageously the water anchor is provided with at least one flap, the flap being arranged to open for through-flow of water when the water anchor sinks through the water.

Advantageously the water anchor is shaped as an inverted pyramid, possibly the frustum of a pyramid, with the “top” of the pyramid facing down.

In a preferred embodiment the pump part is submerged and assembled in combination with the water anchor.

Advantageously the water anchor is located at a depth where the influence from wave forces is insignificant.

The pump part typically comprises a guide pipe and a pump pipe, where the pump pipe seals slidingly against the guide pipe and where the pump pipe is connected to the pontoon. The guide pipe is further connected to its respective check valves, allowing water to flow into the pump pipe when the pump pipe is displaced outwards from the guide pipe. When the pump pipe is displaced in along the guide pipe, water flows from the pump pipe and into the guide pipe, and then on through the pump outlet.

Most advantageously the pontoon is designed as an elongated body, one end part of the elongated body being connected to the pump part. The opposite end portion of the pontoon is equipped with a counterweight.

Advantageously the pontoon has a triangular longitudinal section, with one of the corners of the triangle facing downwards.

A pontoon according to the invention will as a result of its construction move deeper into a trough than an equivalent conventional pontoon. The reason for this is that the counterweight of the pontoon is located higher up along the wave, seeking to float further down into the trough, while at the same time, the buoyancy of the end portion of the pontoon connected to the pump has not yet had time to pull the wave pump far enough up in the water.

In the same way, the end portion of the pontoon connected to the pump will lift above the crest of a wave because the counterweight will seek to flip it out of the water by the counterweight being between the top and bottom of the wave.

Thus it is possible to achieve a considerable increase in effective height between the pontoon connection points for the bottom and top positions of the pump, compared with the use of prior art pontoons. The principle of operation of the elongated pontoon is explained in greater detail in the specific part of the specification.

The following describes a non-limiting example of a preferred embodiment illustrated in the accompanying drawings, in which:

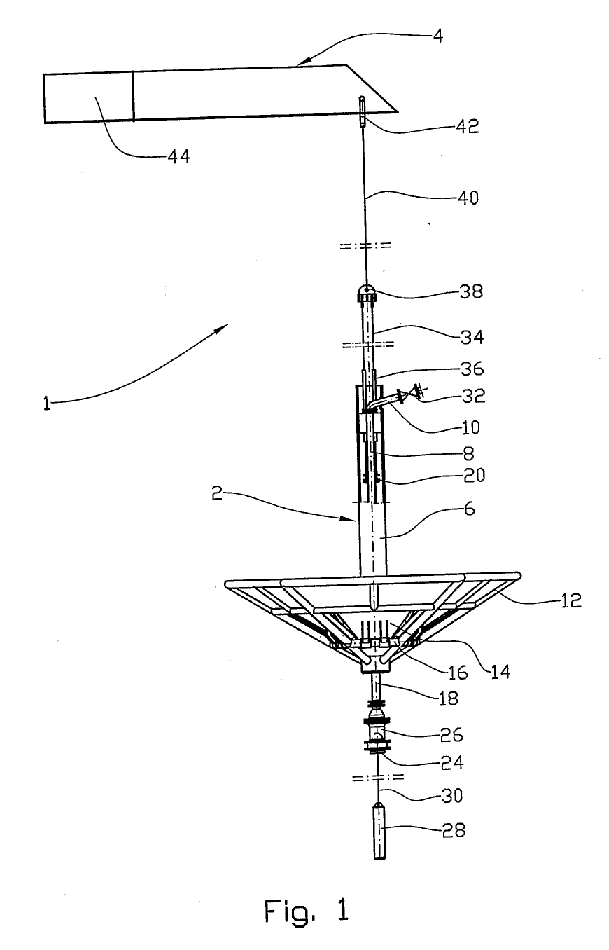

FIG. 1 is a side view of a wave pump according to the invention;

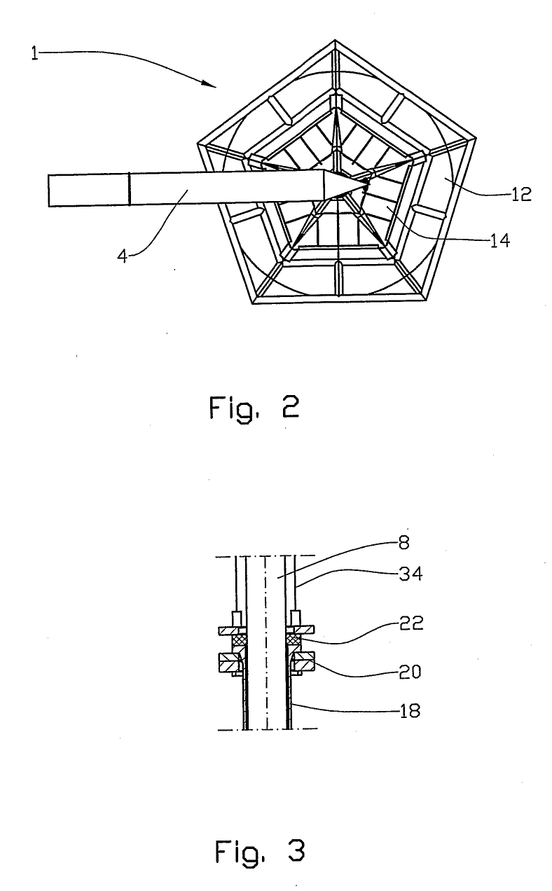

FIG. 2 is a plan view of the wave pump of FIG. 1;

FIG. 3 is a vertical section of the sealing of the pump, on a larger scale;

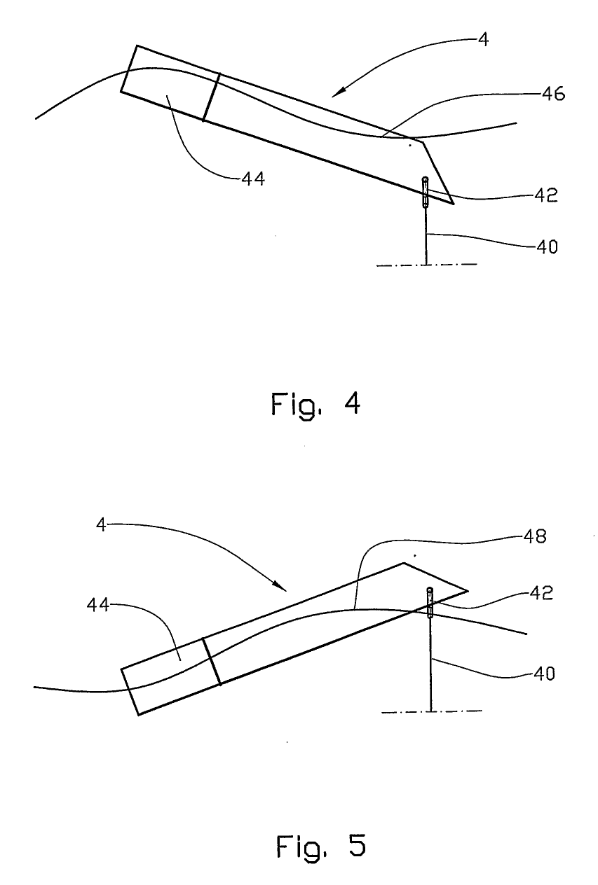

FIG. 4 shows a pontoon in a first position;

FIG. 5 shows the pontoon of FIG. 4 in a second position; and

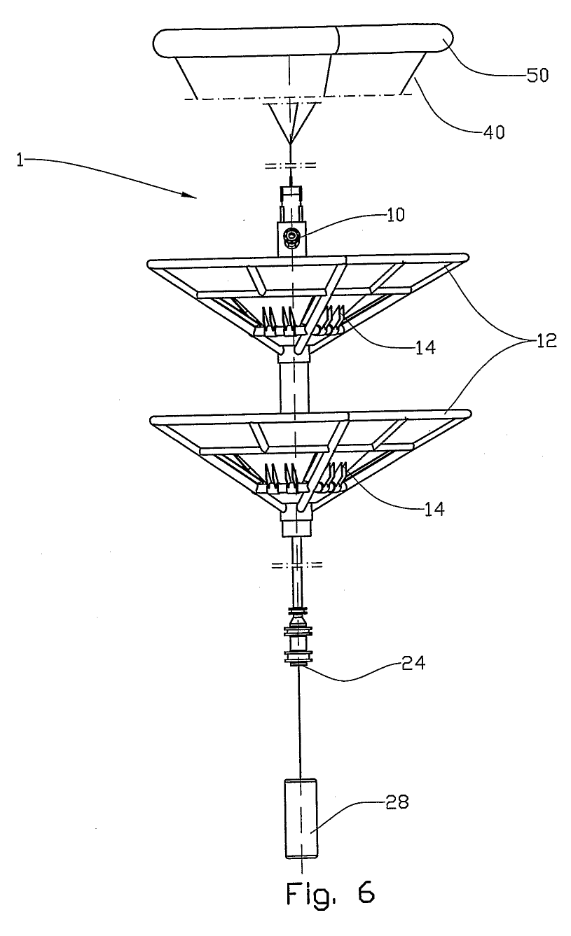

FIG. 6 shows an alternative embodiment of a wave pump.

In the drawings, reference number 1 denotes a wave pump comprising a submerged pump part 2 and a pontoon 4.

The pump part 2 comprises a pump housing 6 in the form of a relatively long, in the operative position approximately vertical, pipe connected to a guide pipe 8 located internally of the pump housing 6 and fixed relative to this.

The upper part of the guide pipe 8 is attached to the pump housing 6, otherwise it projects freely down through the pump housing 6. The outlet 10 of the wave pump 1 is connected to and communicates with the upper part of the guide pipe 8.

The pump housing 6 is connected to a water anchor 12 surrounding the pump housing 6. The water anchor 12 has been given the shape of the frustum of a pyramid having a relatively small height compared with the horizontal dimension, the “top” of the pyramid facing downwards when the pump part 2 is in the operative position.

Such a design of the water anchor 12 has proven to be expedient when it comes to achieving the greatest possible displacement resistance in the water when the pontoon 4 seeks to displace the pump part 2 up through the water.

The water anchor 12 is provided with a number of flaps 14. The flaps 14 are hinged at the lower portion, about a substantially horizontal axis 16.

When the water anchor 12 is displaced up through the water, the flaps 14 are closed, while being rotated about the axis 16 to an open position when the water anchor 12 is displaced down through the water. The flaps 14 cause a significant increase in the draw-down velocity of the pump part 2 compared with a flapless 14 design.

A pump pipe 18 surrounds the free part of the guide pipe 8 in an axially slidable manner. The upper part of the pump pipe 18 is connected to a fastener 20 that includes a seal 22, see FIG. 3, the seal 22 sealing against the guide pipe 8.

At the lower part, the pump pipe 18 communicates with an inlet 24 via a first check valve 26.

A weight 28 is connected to the inlet 24 via a plumb line 30 and is arranged to displace the pump pipe 18 down through the water upon lowering of the pontoon 4.

The outlet 10 communicates with a downstream piping system (not shown) via a second check valve 32.

Pump ropes 34 extend from the fastener 20 via guides 36 in the pump housing 6 up to a rope coupler 38. The rope coupler 38 is connected to the pontoon 4 via a pontoon rope 40.

In the initial position the pump pipe 18 is in the lower position, with the rope coupler 38 abutting the guides 36. The guide pipe 8 and the pump pipe 18 are filled with water.

When the pontoon 4 is lifted by a wave, the pump pipe 18 is displaced upwards by the fastener 20, the pump rope 34, the rope coupler 38 and the pontoon rope 40. The seal 22 prevents water from exiting between the guide pipe 8 and the pump pipe 18, while the first check valve 26 is closed.

This causes a water pressure to build up in the guide pipe 8 and the pump pipe 18, seeking to displace the pump housing 6 upwards. This displacement is prevented essentially by the water anchor 12.

Thus, water at the prevailing pressure exits from the outlet 10 via the second check valve 32, which is open.

When the pontoon 4 is lowered, the weight 28 will pull the pump pipe 18 downwards as the second check valve 32 closes and the first check valve 26 opens to the inflow of water via the inlet 24.

During this phase the entire pump part 2 sinks in the water, as the flaps 14 open and contribute to the water anchor 12 sinking at a greater speed, as explained above. The weight 28, and with this the pump pipe 18, sink at a significantly greater speed than the water anchor 12 and the pump housing 6, thus ensuring the inflow of water to the pump part 2 during the displacement of the pump pipe 18 down along the guide pipe 8.

In a preferred embodiment the pontoon 4 is shaped as an elongated body, see FIGS. 4 and 5. The pontoon 4 may be shaped as a boat or have another appropriate profile, e.g. a triangular section, with one corner of the triangle facing downwards.

The pontoon rope 40 is connected to the pontoon 4 at a pontoon rope attachment point 42 at one end portion of the pontoon, while the opposite end portion of the pontoon 4 is provided with a counterweight 44.

The design of the pontoon 4 causes the pontoon rope attachment point 42 to move below the water surface 46 of a trough when the attachment point 42 is in a trough, see FIG. 4, whereas when the pontoon rope attachment point 42 is in the top position, the pontoon rope attachment point 42 will be lifted to a level above a wave crest 48 due to the counterweight, see FIG. 5.

In an alternative embodiment, see FIG. 6, the wave pump 1 is provided with a conventional pontoon 50 and two water anchors 12.

1. A wave pump device (1) comprising a pump part (2) connected to a pontoon (4, 50),
characterized in that the pump part (2) is further connected to at least one submerged water anchor (12), a pontoon rope (40) extending between the pontoon (4, 50) and the water anchor (12) via the pump part (2).

2. A device in accordance with claim 1,
characterized in that the water anchor (12) is provided with at least one flap (14), the flap (14) being arranged to open for through-flow of water when the water anchor (12) sinks through the water.

3. A device in accordance with claim 1,
characterized in that the water anchor (12) has the shape of an inverted pyramid.

4. A device in accordance with claim 1,
characterized in that the pump part (2) is submerged.

5. A device in accordance with claim 4,
characterized in that the pump part (4) is assembled in combination with the water anchor (12).

6. A device in accordance with claim 1,
characterized in that the pump part (2) comprises a guide pipe (8) and a pump pipe (18), where the pump pipe (18) seals slidingly against the guide pipe (8).

7. A device in accordance with claim 6,
characterized in that the pump pipe (18) is connected to the pontoon (4, 50).

8. A device in accordance with claim 1,
characterized in that the pontoon (4) is elongated and connected to the pump part (2) at one end portion.

9. A device in accordance with claim 8,
characterized in that the opposite end portion of the pontoon (4) is provided with a counterweight.

10. A device in accordance with claim 8,
characterized in that the longitudinal section of the pontoon (4) is triangular, with one of the corners of the triangle facing downwards when in the operative position.
